(19) United States
(12) Patent Application Publication
(10) Pub. No.: US 2006/0035556 A1
(43) Pub. Date: Feb. 16, 2006

(54) Artificial suede-type leather and process for producing the same

(76) Inventors: Kyoko Yokoi, Shiga (JP); Koji Watanabe, Kusatsu (JP); Takafumi Hashimoto, Ritto (JP)

Correspondence Address: IP GROUP OF DLA PIPER RUDNICK GRAY CARY US LLP, 1650 MARKET ST, SUITE 4900, PHILADELPHIA, PA, 19103, US

(21) Appl. No.: 10/522,519

(22) PCT Filed: Aug. 7, 2002
(86) PCT No.: PCT/JP02/08068

§ 371 Date: Feb. 28, 2005

(51) Int. Cl. D04H 1/46; B32B 5/02; D04H 1/00; B32B 27/12; D04H 3/10

(52) U.S. Cl. 442/402; 442/361; 428/904; 442/408; 442/403; 442/415; 442/104

(57) ABSTRACT

This invention relates to a suede-like artificial leather using ultra-fine polyester fibers and a polyurethane, and provides a suede-like artificial leather free from the occurrence of specking and having graceful surface appearance and high light fastness. The suede-like artificial leather comprising a fiber-entangled substrate mainly containing ultra-fine polyester fibers with a fiber fineness of 0.7 dtex or less and a polyurethane, and is dyed, and is wherein said polyurethane contains at least one each of yellow pigments, red pigments and blue pigments, and that said artificial leather satisfies all of the following properties (1) through (3) as measured by the methods described in the specification; (1) The infrared reflectance at 850 nm is 60% or more; (2) The surface temperature during light irradiation is 105° C or lower; (3) The light fastness is class 3 or better. Especially since the suede-like artificial leather of this invention has high light fastness, it can be most suitably used for car seats.

### TECHNICAL FIELD

The present invention relates to a suede-like artificial leather having excellent light fastness, brilliant coloration and good surface appearance, and also to a method for producing said artificial leather.

### BACKGROUND ART

Suede-like artificial leathers with a structure in which a fiber-entangled substrate composed of ultra-fine polyester fibers is impregnated with a polyurethane are used not only in high quality clothing field, but also in various other fields including the interior materials of automobiles and furniture use, since it is excellent in high quality appearance, surface touch, coloration, etc.

The requirements for these artificial leathers in view of sensibility and functions are more and more sophisticated in recent years.

For example, as for the properties required in view of sensibility, further improvement of softness as leather stuff and further improvement of surface appearance are required, and as for the properties required in view of functions, further improvement of light fastness is required.

Among them, the improvement of light fastness is one of the most important properties especially in the use for the interior materials of automobiles.

That is, in the use for the interior materials such as seats of cars running outside, it usually occurs that the interior materials are exposed to light such as sunlight for long periods of time during driving, parking, or the like. If this is repeated for years, there occurs a phenomenon that the color beautiful in the beginning is degraded gradually.

The phenomenon of color degradation (discoloration and fading) and crocking in contrast to the very deep colored beautiful state rich in high quality impression of a new car in the beginning makes one feel a large difference. Furthermore, a car owner who feels affection for the car wishes to use the car for 5 years or 10 years or even for a longer period of time. So, any improvement is required to be made for preventing the color degradation and crocking.

That is, it is desired, as improvement of color fastness, that the initial beautiful color of a brand-new artificial leather is maintained even if it is used in severe conditions for a long period of time.

Meanwhile, usually a suede-like artificial leather composed of ultra-fine polyester fibers and a polyurethane as described above is dyed and colored under the condition of dyeing the polyester.

However, in general, a disperse dye used for dyeing a polyester has an essential problem that since the dye holding power of a dyed polyurethane is weak, the dye is likely to bleed out for immediately lowering the color fastness of the artificial leather product.

To improve this problem, reduction cleaning is carried out for, for example, decomposing or decoloring the dye in the polyurethane. However, on the other hand, the treatment of reduction cleaning involves another problem that the polyurethane becomes while conspicuously.

This means the following. In general, if such dyed artificial leather products are classified in terms of color densities of the products, they can be classified into three classes; light colored products, medium deep colored products and deep colored products. If the reduction cleaning treatment is carried out, especially for medium deep colored or deep colored artificial leathers, the polyurethane becomes whitish, to remarkably lose the color depth, thus remarkably degrading the surface appearance. So, no graceful artificial leather giving a high quality impression can be obtained.

Therefore, hitherto, for sufficiently withstanding the reduction cleaning and for making the whiteness of the polyurethane inconspicuous, a method of adding carbon black particles to a polyurethane is used (JP49-22682B).

As another method, furthermore, to make the whiteness of the polyurethane inconspicuous, a method of adding a black pigment capable of reflecting near infrared radiation such as a perylene-based black pigment or azomethine-azo-based black pigment, to a polyurethane is proposed (JP5-321159A).

However, in the former method (JP49-22682B), in the case where carbon black particles are added to a polyurethane, if light is irradiated, the carbon black absorbs infrared radiation to accumulate heat. So, the surface temperature of the artificial leather per se rises to have a high temperature, for promoting the decomposition of the dye in the ultra-fine fibers. In this regard, the method involves another problem that light fastness is remarkably lowered.

Furthermore, in the latter method (JP5-321159A), in the case where a polyurethane containing a perylene-based black pigment or an azomethine-azo-based black pigment capable of reflecting near infrared radiation is used, the inventors variously examined and found that these black pigments have a problem that the degree of blackness (pitch blackness) is very low, even though a high temperature as caused by said carbon black does not occur. Therefore, even if the pigment concentration is raised, there arise another problem that deep black cannot be obtained, and in addition, a further other serious problem that the reduction cleaning performed after dyeing causes decoloration or discoloration, to virtually deprive the polyurethane of its color in the final product observed or to discolor in such a manner that different color zones are formed. As a result, the color depth is lost, and the surface appearance is remarkably degraded. So, no graceful artificial leather giving a high quality impression can be obtained.

As described above, the conventional artificial leathers with a structure in which a fiber-entangled substrate composed of ultra-fine polyester fibers is impregnated with a polyurethane do not include any artificial leather having excellent light fastness, brilliant coloration and good surface appearance. Moreover, such an artificial leather is not known either.

### DISCLOSURE OF THE INVENTION

In view of the above-mentioned matters, a first object of this invention is to provide a suede-like artificial leather using ultra-fine polyester fibers, which has all of excellent light fastness, brilliant coloration and good surface appearance.

Furthermore, a second object of this invention is to provide a method for producing a suede-like artificial leather using ultra-fine polyester fibers, which have the above-mentioned features.

The suede-like artificial leather of this invention for achieving said first object has the following constitution.

That is, a suede-like artificial leather, which comprising a fiber-entangled substrate mainly containing ultra-fine polyester fibers with a fiber fineness of 0.7 dtex or less and a polyurethane and is dyed, wherein said polyurethane contains at least one each of yellow pigments, red pigments and blue pigments, and said artificial leather satisfies all of the following properties (1) through (3) as measured by the methods described in the specification;

(1) The infrared reflectance at 850 nm is 60% or more;

(2) The surface temperature during light irradiation is 105° C. or lower;

(3) The light fastness is class 3 or better.

Furthermore, the method for producing a suede-like artificial leather of this invention for achieving said second object has the following constitution.

That is, a method for producing a suede-like artificial leather excellent in light fastness, in which a fiber-entangled substrate mainly containing ultra-fine polyester fibers with a fiber fineness of 0.7 dtex or less is impregnated with a polyurethane, wherein the polyurethane solution used contains at least one each of yellow pigments, red pigments and blue pigments in such a manner that the coagulated film of the polyurethane solution satisfies all the following properties (4) through (6) when it is evaluated according to the methods described in the specification;

(4) The infrared reflectance at 850 nm is 60% or more;

(5) The discoloration ratio after reduction cleaning is 20% or less;

(6) The chroma is 10 or less.

This invention enables the production of a suede-like artificial leather having graceful surface appearance with a deep hue free from specking and high light fastness, which has been a problem remaining unsolved in the suede-like artificial leathers using ultra-fine polyester fibers.

The suede-like artificial leather of this invention thus obtained can be used suitably not only for applications as materials such as the interior materials of automobiles, furniture use, bags, shoes, gloves and the like but also for clothing use.

### THE BEST MODES FOR CARRYING OUT THE INVENTION

The suede-like artificial leather of this invention and the production method thereof are described below.

The suede-like artificial leather of this invention comprising a fiber-entangled substrate mainly containing ultra-fine polyester fibers with an average fineness of 0.7 dtex or less and a polyurethane, and is formed in such a manner that the fiber-entangled substrate is impregnated with the polyurethane.

As said ultra-fine polyester fibers, for example, polyethylene terephthalate or any of its copolymers, polybutylene terephthalate or any of its copolymers, or polypropylene terephthalate or any of its copolymers can be preferably used.

The ultra-fine fibers used in this invention can be obtained, for example, by a direct spinning method, or splitting a composite fiber convertible into a bundle of ultra-fine fibers and consisting of plural components, or dissolving and removing at least one component from a composite fiber convertible into a bundle of ultra-fine fibers and consisting of plural components. The impregnation of the polyurethane per se can be carried out either before or after said splitting or said dissolution and removal of one component.

The single fiber fineness of the ultra-fine fibers used in this invention is 0.7 dtex or less. However, for making the surface smooth and soft hand, 0.5 dtex or less is preferred. Furthermore, in view of denseness and coloration, a range from 0.01 dtex to 0.3 dtex is preferred.

In the case where the ultra-fine fibers are produced by removing at least one component from a composite fiber convertible into a bundle of ultra-fine fibers, the combination is only required to be such that the polymer component to be removed can be chemically or physically removed without substantially damaging the ultra-fine fibers. The polymer is not especially limited to a specific polymer, but it is preferred that the polymer is different from the polymer of the ultra-fine fibers in the solubility in a solvent or in decomposability. Preferred examples include polyolefins, polystyrene and its copolymers, polyvinyl alcohol, polyamides, alkali-soluble copolyesters, etc.

As the form of the fibers, for example, not only an ordinary circular section, but also a hollow section or other shaped section such as triangular section or Y-type fan-shaped section, or sheath-core type conjugate structure fibers can be used. Forms selected from them can be combined, considering the section formability as ultra-fine fibers, spinnability, drawability, etc.

In this invention, to form the fiber-entangled substrate, a long-fiber web is formed as in the spun-bond method, or a web is formed from short fibers by a conventional method such as using a card cross-lapper or a random webber. Then, needle punching or water-jet punching or a combination of them can be used for forming the fiber-entangled sheet.

To let the fiber-entangled sheet have a higher strength, it is preferred that the fiber-entangled substrate has a structure in which a nonwoven fabric containing the ultra-fine fibers and a woven fabric or a knitted fabric are integrated. The structure can be obtained by entangling and integrating the fibers in said web with the woven fabric or knitted fabric. In the case where a composite fiber convertible into a bundle of ultra-fine fibers is used, it is subsequently made into ultra-fine fibers using a solvent, heat treatment or mechanical treatment.

In this case, a method in which a woven fabric is laminated on both the sides of or either side of a web, the laminate being treated to achieve entanglement, or a method in which several sheets of said fiber-entangled substrate are overlaid and re-treated to achieve entanglement, the laminate being later sliced in the direction perpendicular to the thickness direction, for obtaining two sheets respectively with a thickness corresponding to one half of the thickness of the laminate, can be used as found suitable for the intended purpose.

Then, in this invention, the fiber-entangled substrate containing these ultra-fine fibers is given a polyurethane. The polyurethane resin is described below in detail.

As the polyurethane used in this invention, basically any polyurethane can be used. However, in view of processability, product quality and the like, it is preferred to use any one or two or more in combination of polycarbonate diols, polyester diols and polyether diols respectively having an average molecular weight of 500 to 3000 as the soft segment.

Especially in view of durability, it is preferred to use a polyurethane elastomer formed using a compound containing 30 wt % or more, based on the weight of all the polymer diols, of a polycarbonate diol. If the rate of the polycarbonate diol in the polymer diols is less than 30 wt %, the durability may be insufficient in some cases, and this is not preferred for some applications. In the polycarbonate diol in this case, diol structures are connected through carbonate bonds for forming a polymeric chain having a hydroxyl group each at its both ends. The diol structure is decided by the glycol used as a raw material, and the glycol is not especially limited. It can be, for example, 1,6-hexanediol, 1,5-pentanediol, neopentyl glycol, 3-methyl-1,5-pentanediol, or any of their mixtures, etc.

Then, any of these polyurethanes is dissolved or dispersed into a solvent, to produce the polyurethane solution to be impregnated into the fiber-entangled substrate. The polyurethane solution can be provided, for example, as a solution of an organic solvent or as an emulsion.

In this invention, at least one each of the yellow pigments, red pigments and blue pigments with the following properties are added to the polyurethane. For a solvent solution, DMF (dimethylformamide) or the like is added, and for an emulsion, water is added as a solvent. The solution is then stirred and mixed to prepare the polyurethane solution.

In this case, as required, additives such as an antioxidant, ultraviolet light absorber, photostabilizer, antistatic agent, flame retarder, softening agent, coagulation regulator and colorant can also be added.

It is preferred that the pigments to be added to the polyurethane are not decomposed or decolored during reduction cleaning, and can reflect the infrared radiation for decreasing the heat accumulation during light irradiation and for improving light fastness.

Particularly, it is preferred to select the pigments suitable for the intended purpose from among the numerous yellow pigments, red pigments and blue pigments respectively capable of reflecting infrared radiation.

In this invention, being yellow, being red and being blue means that they satisfy the following definitions.

That is, this means that each polyurethane film produced using the polyurethane concerned and the pigment of each hue (yellow, red or blue) indicates the following numerical range. The method for producing the polyurethane resin is the same as in the method for measuring the discoloration ratio after reduction cleaning of pigments described below.

As the measuring instrument, Minolta Spectrophotometer CM-3700d or a functionally equivalent instrument is used. As the light source, a halogen lamp is used, and D65 light source is used as the measuring light source. The angle of visibility is 10 degrees, and magnesium oxide is used as the white plate for reference. The measuring diameter is 25.4 mm, and SCE is used for treatment of regularly reflected light. Under these conditions, the h* (hue angle) and C* (chroma) in the L*C*h* color system specified by CIE (Commission Internationale de l'Eclairage) are obtained.

And in this invention, being yellow refers to a state in which the value of h* is 45 to less than 135 while the value of C* is 10 or more, and being blue refers to a state in which the value of h* is 155 to less than 310 while the value of C* is 10 or more. Being red refers to a state in which the value of h* is 0 to less than 45 or 315 to less than 360 while the value of C* is 10 or more.

The selection of the pigments and the mixing ratio of the pigments are made or decided, as described below in detail, to ensure that the coagulated film of the polyurethane solution containing the respective pigments satisfies all the three properties of being 20% or less in the discoloration ratio after reduction cleaning, 60% or more in the infrared reflectance at 850 nm, and 10 or less in chroma, when tested respectively by the test methods described later.

The suede-like artificial leather of this invention reflects, on its surface, infrared radiation, for being prevented from rising in temperature due to the heat accumulated during light irradiation, hence being prevented from being lowered in light fastness, and can prevent the pigments from being discolored by reduction cleaning, being able to sustain a graceful color tone.

The suede-like artificial leather of this invention is 60% or more in the infrared reflectance of the artificial leather surface at 850 nm when measured by the method described later. If the value is less than 60%, the effect of preventing the heat accumulation during light irradiation is so small as to raise the surface temperature, and the intended effect of this invention cannot be obtained.

Furthermore, the artificial leather of this invention is 105° C. or less in the surface temperature during light irradiation. If the surface temperature during light irradiation is higher than 105° C., the artificial leather cannot have high light fastness, and generally the light fastness cannot be class 3 or better. So, the intended effect of this invention cannot be obtained.

If the suede-like artificial leather of this invention is more preferably constituted, the surface temperature during light irradiation is 100° C. or lower. If it is further more preferably constituted, the temperature is 95° C. or lower, and if most preferably constituted, the temperature is 90° C. or lower. So, it can have more excellent high light fastness.

The artificial leather of this invention comprising a polyurethane with such a discoloration ratio after reduction cleaning, and having said infrared radiation reflection capability and said property of surface temperature during light irradiation can be produced by using the pigments to be added to the polyurethane, under a specific recipe satisfying said specific properties.

Particularly, for example, the selection of pigments, the combination of the pigments and the added concentrations of the pigments can be adapted to satisfy the above-mentioned respective properties of (1) through (6).

As suitable pigments having the above-mentioned property values, enumerated are compounds of diketopyrrolopyrrole type, anthraquinone type, perylene type, perynone type, quinacridone type, azo type, polyazo type, condensed azo type, imidazolone type, phthalocyanine type, isoindoline type, indigo type, thioindigo type, azomethine type, azomethine-azo type, dioxazine type, indanthrone type, flavanthrone type, pyranthrone type, etc., though not necessarily limited to them.

However, according to various findings of the inventors, among those enumerated above, diketopyrrolopyrrole-based pigments are preferred as red pigments, and phthalocyanine-based pigments are preferred as blue pigments. Furthermore, as yellow pigments, azo-based pigments can be respectively especially suitably used.

The property values of (4) through (6) of the polyurethane solution containing said pigments refer to the values of the polyurethane as a whole containing all pigments obtained by mixing all the pigments used for the polyurethane. Even if any pigment used alone does not satisfy the above property values, it is only required that the values obtained from the pigments mixed together are in the respective ranges. Using the pigments as a mixture is meaningful.

If the pigments are used as a mixture as described above, an artificial leather deeper in hue and more excellent in surface appearance than a case of using only any one of the pigments can be produced.

When the pigments are mixed, the mixing ratio is such that the chroma of the coagulated film of the polyurethane solution to be impregnated becomes 10 or less. In this case, the chroma of the coagulated film of the polyurethane solution being 10 or less means that the polyurethane having said pigments mixed has a hue closer to an achromatic color such as black or gray. That is, the chroma of the coagulated film of the polyurethane solution being 10 or less means being more blackish.

If at least one each of yellow pigments, red pigments and blue pigments are mixed to achieve such a chroma, the polyurethane presents a calm hue and deepens the hue of the artificial leather, providing appearance giving a high quality impression.

When at least one each of yellow pigments, red pigments and blue pigments are mixed in this invention, according to various findings of the inventors, it is desirable to mix at a ratio of yellow pigment:red pigment:blue pigment=1 to 3:1 to 3:1 to 3 (by weight), though it is difficult to generally specify.

That is, it is only required that the amounts of the respective pigments are virtually equal, and even if the amount of one pigment is large, it is desirable that the amount is about 2 to 3 times the amount of another pigment. The mixing work per se can be carried out by a pigment manufacturer or an artificial leather manufacturer.

It is preferred that the added amount in total of the pigments is such that the total solid weight of the pigments is from 0.03 to 30 wt % based on the solid weight of the polyurethane. A more preferred range is from 0.05 to 15 wt %. Less than 0.03 wt % is not preferred, since the effect of coloring the polyurethane is small. Furthermore, more than 30 wt % may not be preferred since the physical properties of the product may be affected.

In this invention, the polyurethane solution having predetermined pigments mixed as described above is impregnated into the fiber-entangled substrate, and is solidified. The solidification method in this case can be either a wet method or a dry method. However, in the case where soft hand is desired, a wet method is preferred.

Furthermore, as for the applied amount, it is preferred that the solid weight of the polyurethane contained is 10 to 60 wt % based on the weight of the polyester fibers. Less than 10 wt % is not preferred, since the strength of the obtained artificial leather may be weak, and more than 60 wt % is not preferred either, since the hand may become hard.

Moreover, this sheet is compressed to substantially remove the solvent, and dried.

Then, the sheet is, as required, split into halves in the thickness direction (sliced to have a thickness of ½ each), and they are raised respectively at lease on one side, to obtain napped sheets having the polyurethane colored with pigments.

Furthermore, it is necessary that the suede-like artificial leather is dyed. That is, only when the artificial leather uses such a polyurethane and is dyed, it has graceful surface appearance giving a high quality impression.

As the dyeing machine used for dyeing, any of usually used conventional machines can be used, and a jet dyeing machine can be especially preferably used. As the dye used, a usually used dye with excellent light fastness selected, for example, from disperse dyes and vat dyes is desirable, and a dye capable of reflecting infrared radiation is more preferred.

Thus, the intended artificial leather of this invention can be obtained.

The following measuring methods 1 through 6 used in this invention are described below.

1. Method for measuring the discoloration ratio after reduction cleaning of the pigments in a polyurethane film containing the pigments

2. Method for measuring the infrared reflectance of a polyurethane film containing pigments

3. Method for measuring the chroma of a polyurethane film containing pigments

4. Method for measuring the infrared reflectance of an artificial leather

5. Method for measuring the light fastness of an artificial leather

6. Method for measuring the surface temperature of an artificial leather during light irradiation
1. Method for measuring the discoloration ratio after reduction cleaning of the pigments in a polyurethane film containing the pigments

The discoloration ratio after reduction cleaning of pigments in this invention refers to the degree in the change of L*-value before and after the reduction cleaning of the film formed using the polyurethane solution to be impregnated into a fiber-entangled structure when the artificial leather of this invention is produced. It is measured as described below.

At first, a polyurethane solution (mixed solution consisting of a polyurethane, pigments, solvent, etc.) to be impregnated is prepared. This solution is adjusted to ensure that the solid content of the polyurethane resin becomes 20% based on the weight of the entire solution. If the solution concentration is low, the solution can be evaporated using an evaporator, or a solution that allows a polyurethane solid content of 20% to be achieved without changing the ratio of the pigment to the polyurethane can be prepared separately.

The solution prepared like this is used to form a film for measurement. For forming a film, in the case where a polyurethane dissolved in an organic solvent is used as the polyurethane to be impregnated, the coagulated film is produced by the following method. The prepared polyurethane solution is cast onto a glass sheet of 40 cm square with the clearance adjusted to a thickness of about 300 μm using a coating knife. The coated glass sheet is immediately is immersed in about 10 liters of water having a temperature of 20° C. prepared beforehand in a vessel, in such a manner that the glass sheet is kept horizontal in the water with its coating surface kept upward and perfectly submerged in water. The water temperature is kept in a range of 20° C.±3° C., and one hour later, the glass sheet is taken out. Then, the polyurethane film is separated from the glass sheet and dried at 80° C. for 1 hour, to obtain a coagulated film for measurement.

Furthermore, in the case where a polyurethane emulsion is used as the polyurethane to be impregnated, the film is formed according to the following method. At first, a horizontal aluminum sheet of 40 cm square provided with a frame for preventing the liquid from spilling from its sides is prepared, and the said polyurethane solution is poured to a liquid height of 1 mm. Then, it is dried at 130° C. for 20 minutes, while it is kept horizontal, and the film is separated from the glass sheet.

Subsequently either of the films obtained is cut into 10 cm squares that are treated for reduction cleaning under the following conditions.
A. Conditions of reduction cleaning

(1) Treating agent for reduction cleaning:
Caustic soda (solid): 3 grams
Hydrosulfite: 6 grams
GURANUP US20 (produced by Sanyo Chemical Industries, Ltd.): 1.5 grams
Water: 300 grams

(2) Treatment temperature and period for reduction cleaning

The treating solution is heated from about 30° C. to 80° C. at such a speed as to reach 80° C. in 30 minutes, and used for treating at 80° C. for 30 minutes, then being cooled to 40° C., taking 30 minutes.

(3) Treating device for reduction cleaning: UR-MFNI-COLOR (produced by Texam Co., Ltd.)

After completion of reduction cleaning treatment, running water is used to wash the film so that the treating solution can be substantially perfectly removed, and the washing is followed by drying at a temperature of 40° C. or lower.

The L*-values of the polyurethane film before and after the reduction cleaning treatment are measured, and with the value before treatment as L*₁ and the value after treatment as L*₂, the value A obtained from the following formula is called the discoloration ratio after reduction cleaning in this invention.
A=(L*₂−L*₁)/L*₁×100
B. Measurement of L*-value

As the measuring instrument, Minolta Spectrophotometer CM-3700d (produced by Minolta Co., Ltd.) is used. If the measuring instrument cannot be used, a functionally equivalent instrument is used. As the light source, a halogen lamp is used, and D54 light source is used as the measuring light source. The angle of visibility is 10 degrees, and magnesium oxide is used as the white plate for reference. The measuring diameter is 25.4 mm, and SCE is used for treatment of regularly reflected light. Under these conditions, the L*-value specified by CIE (Commission Internationale de l'Eclairage) is measured. For measurement, four overlaid films are used.
2. Method for measuring the infrared reflectance of a polyurethane film containing pigments

The infrared reflectance of a polyurethane film containing pigments in this invention refers to the infrared reflectance of the coagulated film prepared using the polyurethane solution to be impregnated into a fiber-entangled substrate when the artificial leather of this invention is produced. It is measured as described below.

A film is prepared as described for the measurement of the discoloration ratio after reduction cleaning of pigments.

The film is cut into 10 cm squares, and four squares are overlaid for measuring the reflectance at 850 nm by the following method. The measuring instrument used is spectrophotograph U3400 produced by Hitachi, Ltd. Furthermore, the reference white plate is a magnesium oxide plate.

At first, the white plate is irradiated with light of 850 nm from the spectrophotograph, and the reflected light is condensed by an integrating sphere. The intensity of the reflected light is measured, and the value is expressed as R100.

Then, similar measurement is performed for a sample to be measured, and the obtained value is expressed as RSamp.

Using the R100 values and RSamp value obtained as described above, the value of the infrared reflectance of this invention is obtained from the following formula.
Infrared reflectance=(Rsamp)/(R100)×100
3. Method for measuring the chroma of a polyurethane film containing pigments

The chroma of a polyurethane film containing pigments in this invention refers to the chroma of the polyurethane film produced using the polyurethane solution to be impregnated into a fiber-entangled substrate when the artificial leather of this invention is produced. The coagulated film produced as described for measuring the discoloration ratio after reduction cleaning is cut into 10 cm squares, and four squares are overlaid for measuring under the following conditions. The measured chroma is called the chroma of the polyurethane film.

As the measuring instrument, Minolta Spectrophotometer CM-3700d or a functionally equivalent instrument is used. As the light source, a halogen lamp is used, and D65 light source is used as the measuring light source. The angle of visibility is 10 degrees, and magnesium oxide is used as the white plate for reference. The measuring diameter is 25.4 mm, and SCE is used for treatment of regularly reflected light. Under these conditions, the a* and b* in the L*a*b* color system specified by CIE (Commission Internationale de l'Eclairage) are obtained. The (a*²+b*²)^{1/2} obtained using the obtained values is the chroma of the polyurethane film in this invention.
4. Method for measuring the infrared reflectance of an artificial leather

The measuring method and definition are quite the same as in the above-mentioned measurement of the infrared reflectance of pigments, except that an artificial leather is used instead of the coagulated film of a polyurethane as the sample, and that the nap surface (the so-called front surface of a product) is used as the surface to be measured.
5. Method for measuring the light fastness of an artificial leather

An artificial leather is cut into a 7 cm square as a sample, and its nap surface (the so-called front surface of a product) is used as the surface to be exposed to light. A polyurethane foam having the same size (7 cm square) as the sample, a thickness of about 10 mm and a specific gravity of about 0.02±0.005 is laminated on the back surface (the surface not exposed to light) of the sample, and the laminate is set in a device for performing light irradiation under the following conditions. After completion of light irradiation, the class is judged using the gray scale for color change specified in JIS L 0804.

As the light irradiator, a xenon weather meter {SC750-WAP (produced by Suga Test Instrument)} is used to perform light irradiation 38 cycles, with the following treatments (A) and (B) as one cycle.

(A) Irradiating at a radiance of 150 W/m², with a 73° C. black panel and at a relative humidity of 50% RH for 3.8 hours

(B) Irradiating at a radiance of 0 W/m² (without irradiation), at a black panel temperature of 38° C. and at a relative humidity of 95% RH for 1 hour

The class is judged in reference to a 9-stage criterion of class 1, class 2, class 3, class 4 and class 5, with intermediate classes added between the respective classes as class 1-2, class 2-3, class 3-4 and class 4-5 to the above-mentioned 5-stage criterion. For evaluation, at least three points are taken from a larger-sized sample at random for measurement, and the observed classes are averaged for judgment.
6. Method for measuring the surface temperature of an artificial leather during light irradiation

An artificial leather cut into a 7 cm square is prepared, and thermolabels (Thermolabel 5E-100 and Thermolabel 5E-75, produced by Nichiyu Giken Kogyo Co., Ltd.) were stuck to the nap surface (so-called front surface of a product), and an urethane foam having the same size (7 cm square) as that of the sample, a thickness of about 10 mm and a specific gravity of about 0.02±0.005 is laminated on the back surface of the sample on the side opposite to the nap surface. It is set in a device so that the thermolabel surfaces can be irradiated with light, and then irradiated with light. After completion of light irradiation, whether the colors of the thermolabels have changed is observed to measure the surface temperature.

For measuring the surface temperature, at least three points are taken from a larger-sized sample at random for measurement, and the temperatures of the at least three samples are averaged.

The light irradiation is performed under the same conditions as used for the above-mentioned measurement of light fastness.

That is, as the light irradiator, a xenon weather meter {SC750-WAP (produced by Suga Test Instrument)} is used to perform light irradiation 38 cycles, with the following treatments (A) and (B) as one cycle.

(A) Irradiating at a radiance of 150 W/m², with a 73° C. black panel and at a relative humidity of 50% RH for 3.8 hours

(B) Irradiating at a radiance of 0 W/m² (without irradiation), at a black panel temperature of 38° C. and at a relative humidity of 95% RH for 1 hour

### EXAMPLES

This invention is described below in reference to examples.

The light fastness and surface temperature of each artificial leather product and the infrared reflectance and chroma, in this invention in the respective examples and comparative examples were measured according to the methods described above. Specking was evaluated as described below.
7. Evaluation of specking

In this invention, specking refers to a phenomenon in which the appearance on the surface of an artificial leather is degraded since the polyurethane on the surface of the artificial leather becomes whitish to cause a color difference between the polyurethane and the fibers. The occurrence of specking was evaluated with eyes. A surface free from specking is indicated by o; a surface with some specking, Δ; and a surface with very conspicuous speckling, x.

### Example 1

Staple fibers having polymers disposed in each other, with polyethylene terephthalate as an island component, polystyrene as a sea component, an island/sea ratio of 80/20 wt %, 25 islands per fiber and a conjugate fiber fineness of about 5 dtex were used and formed into a web using a card cross-lapper, which was then needle-punched to make a felt with a unit weight of 600 g/m². The felt was treated for being shrunken, and dried. Subsequently, the felt was impregnated with a polyvinyl alcohol aqueous solution, and dried.

The sheet was immersed in trichloroethylene, and mangled to remove the sea component, and the residue was dried.

On the other hand, an azo-based yellow pigment, and a diketopyrrolopyrrole-based red pigment, and a phthalocyanine-based blue pigment were dispersed and dissolved into dimethylformamide respectively by 0.2 wt %, 0.3 wt % and 0.25 wt % as solid contents based on the solid content of the following polyurethane, while a polycarbonate-based polyurethane was dispersed and dissolved by 12 wt % based on the weight of the entire solution, to obtain a polyurethane solution. The infrared reflectance of the coagulated film of the polyurethane solution was 88%.

The polyurethane solution was immersed into the island fibers by about 29 parts as solid content per the island fibers, and solidified by a wet method, and the impregnated fibers were compressed and squeezed using rolls so that dimethylformamide could be substantially perfectly removed. The sheet was washed with warm water and dried.

Then, the sheet was sliced into two sheets in the thickness direction, and one of the sheets was raised on one side using sand paper, to obtain a napped sheet.

The napped sheet was dyed beige using a disperse dye excellent in light fastness, and treated for finishing.

The average single fiber fineness of the ultra-fine polyester fibers constituting the suede-like artificial leather was about 0.2 dtex, and the chroma obtained by solidifying the used polyurethane solution by a wet method was 2.5.

The suede-like artificial leather was free from the occurrence of specking, being a suede-like artificial leather with a calm color tone giving a high quality impression.

The infrared reflectance of the suede-like artificial leather at 850 nm was measured and found to be 85%, and the surface temperature was measured and found to be 75° C. Furthermore, the light fastness was evaluated and found to show excellent performance of class 4. Moreover, the chroma of the pigments, the discoloration ratio after reduction cleaning of the pigments and the occurrence of specking were respectively evaluated. The results are shown in Table 1.

### Examples 2, 3 and 4, and Comparative Examples 1, 2, 3 and 4

Suede-like artificial leathers were obtained as described for Example 1, except that the pigments added to the polyurethane and their concentrations were as stated in Table 1, and that the hue of dyeing was dark gray.

Evaluated were the light fastness of each artificial leather, the surface temperature of each artificial leather, the occurrence of specking in each artificial leather, the infrared reflectance of each artificial leather, the infrared reflectance of pigments, the chroma of pigments, and the discoloration ratio after reduction cleaning of pigments. The results are shown in Table 1.

The artificial leather obtained in Example 2 had excellent light fastness of class 4, and was free from the occurrence of specking, excellent in surface appearance, and dark gray.

The artificial leather obtained in Example 3 had excellent light fastness of class 3-4, was free from the occurrence of specking, and had a calm hue deeper than that of Example 2.

The artificial leather obtained in Example 4 had excellent light fastness of class 3-4, was free from the occurrence of specking, and had a deep and calm hue, though the added amounts of pigments were smaller than those of Examples 2 and 3.

Comparative Example 1 was free from specking and excellent in surface appearance, but had poor light fastness of class 2.

The artificial leather of Comparative Example 2 was had somewhat poor light fastness of class 2-3, was not deep in hue, had specking to some extent, and was poor in surface appearance, hence poor in high class impression.

The artificial leather of Comparative Example 3 had excellent light fastness of class 4, but had much specking, and was not deep in hue, being very poor in surface appearance.

The artificial leather of Comparative Example 4 had no effect of polyurethane coloration though the amount of the pigment added to the polyurethane was large, had much specking, and was not deep in hue, being very poor in surface appearance.

TABLE 1

| | | | | | | | Property values of pigments | | |
|---|---|---|---|---|---|---|---|---|---|
| | | | Property values of artificial leather | | | | | | Discoloration |
| | | | Infrared | Light | Surface | | Infrared | | ratio after |
| | | Concentrations | reflectance | fastness | temperature | | reflectance | Chroma | reduction |
| | Pigments added | of pigments (%) | (%) | (class) | (° C.) | Specking | (%) | C* | cleaning (%) |
| Example 1 | Yellow (azo type) | 0.2 | 85 | 4 | 75 | ∘ | 88 | 2.5 | 2.0 |
| | Red (DPP type) | 0.3 | | | | | | | |
| | Blue (phthalocyanine | 0.25 | | | | | | | |
| | type) | | | | | | | | |
| Example 2 | Yellow (azo type) | 2.3 | 80 | 4 | 80 | ∘ | 83 | 1.8 | 1.6 |
| | Red (DPP type) | 1.5 | | | | | | | |
| | Blue (phthalocyanine | 1.4 | | | | | | | |
| | type) | | | | | | | | |
| Example 3 | Yellow (azo type) | 1.9 | 79 | 3-4 | 83 | ∘ | 82 | 1.3 | 2.7 |
| | Red (DPP type) | 0.8 | | | | | | | |
| | Red (anthraquinone | 0.9 | | | | | | | |
| | type) | | | | | | | | |
| | Blue (phthalocyanine | 2.1 | | | | | | | |
| | type) | | | | | | | | |
| Example 4 | Yellow (azo type) | 0.8 | 81 | 3-4 | 86 | ∘ | 78 | 2.1 | 1.3 |
| | Yellow (imidazolone | 0.7 | | | | | | | |
| | type) | | | | | | | | |
| | Red (DPP type) | 0.7 | | | | | | | |
| | Red (anthraquinone | 0.8 | | | | | | | |
| | type) | | | | | | | | |
| | Blue (phthalocyanine | 2.0 | | | | | | | |
| | type) | | | | | | | | |
| Comparative | Carbon black | 2.0 | 37 | 2 | 115 | ∘ | 15 | 0.9 | 0.3 |
| Example 1 | | | | | | | | | |
| Comparative | Carbon black | 0.06 | 51 | 2-3 | 110 | Δ | 32 | 1.5 | 0.2 |
| Example 2 | | | | | | | | | |
| Comparative | No pigment added | 0.0 | 88 | 4 | 75 | x | 89 | 1.6 | 0.0 |
| Example 3 | | | | | | | | | |
| Comparative | Black pigment | 12.6 | 73 | 2-3 | 95 | x | 75 | 2.8 | 63 |
| Example 4 | (perylene type) | | | | | | | | |

DPP: Abbreviation of diketopyrrolopyrrole
Note:
C*: (a*² + b*²)^{1/2}

Industrial Applicability

The suede-like artificial leather obtained by this invention is a suede-like artificial leather having, especially, high quality appearance, surface touch, brilliant coloration and good surface appearance. It is also very excellent in the light fastness of its coloration. Because of these properties, the artificial leather can be favorably used not only in high quality clothing field, but also in various other fields including the interior materials of automobiles such as, especially, car seats, and furniture use.

This invention can provide a suede-like artificial leather highly improved in light fastness, which can provide more available hue variations, especially, for the interior materials of automobiles such as car seats, to expand the market and to encourage new demands, even though the conventional deep colored or medium deep colored artificial leathers could not be used because of such problems as fading and crocking.

1. A suede-like artificial leather, which comprising a fiber-entangled substrate mainly containing ultra-fine polyester fibers with a fiber fineness of 0.7 dtex or less and a polyurethane, and is dyed, wherein said polyurethane contains at least one each of yellow pigments, red pigments and blue pigments, and said artificial leather satisfies all of the following properties (1) through (3) as measured by the methods described in the specification;
(1) The infrared reflectance at 850 nm is 60% or more;
(2) The surface temperature during light irradiation is 105° C. or lower;
(3) The light fastness is class 3 or better.

2. A suede-like artificial leather, according to claim 1, wherein the polyurethane is mainly a polycarbonate-based polyurethane.

3. A method for producing a suede-like artificial leather excellent in light fastness, in which a fiber-entangled substrate mainly containing ultra-fine polyester fibers with a fiber fineness of 0.7 dtex or less is impregnated with a polyurethane, wherein the polyurethane solution used contains at least one each of yellow pigments, red pigments and blue pigments in such a manner that the coagulated film of the polyurethane solution satisfies all the following properties (4) through (6) when it is evaluated according to the methods described in the specification;
(4) The infrared reflectance at 850 nm is 60% or more;
(5) The discoloration ratio after reduction cleaning is 20% or less;
(6) The chroma is 10 or less.

4. A method for producing a suede-like artificial leather, according to claim 3, wherein a polycarbonate-based polyurethane is mainly used as the polyurethane.
